(19) United States
(12) Patent Application Publication
(10) Pub. No.: US 2013/0009350 A1
(43) Pub. Date: Jan. 10, 2013

(54) Semiactive Wheel Suspension

(76) Inventor: Friedrich Peter Wolf-Monheim, Aachen (DE)

(21) Appl. No.: 13/532,286

(22) Filed: Jun. 25, 2012

(30) Foreign Application Priority Data
Jul. 8, 2011 (DE) 102011078880.8

(51) Int. Cl. B60G 11/48; B60G 11/54; B60G 17/02

(52) U.S. Cl. 267/33; 267/259

(57) ABSTRACT

The invention relates to a wheel suspension which has a spring system (1) which has a first spring element (2) and at least one second spring element (3), the first spring element (2) being held between two supporting elements (4, 5).

The first spring element (2) has a first actuator (6), the second spring element (3) at the same time also having a second actuator (7) which is independent of the first actuator (6).

The present invention relates to a wheel suspension which has a spring system, which spring system has a first spring element and at least one second spring element, the first spring element being held between two supporting elements.

DE 10 2004 019 991 A1 discloses a wheel suspension which has a main spring and an additional spring. The additional spring is formed from a plastic. A housing of a vibration damper is supported against a vehicle body via the additional spring. In order to create a controllable or partially active motor vehicle chassis, an activatable piston arrangement is provided, via which the position of the support of the additional spring relative to the vehicle body can be adjusted with respect to the longitudinal axis of the piston rod. The overall spring travel can be reduced or increased by changing the position of the support of the additional spring. If for example, the foot of the additional spring were displaced downward in relation to the vehicle body, this would lead to a higher supporting part of the additional spring than on the main spring. Conversely, displacement of the foot of the additional spring upward would lead to relieving the load on the additional spring, in which case the supporting portion of the main spring and the residual spring compression travel will be enlarged. This could permit a level-controlling engagement during loading and unloading of the vehicle, wherein the vehicle body can be raised or lowered only via the additional spring.

DE 10 2009 016 229 A1 acknowledges DE 10 2006 056 762 A1 which has disclosed a height adjustment means provided on a suspension strut axis. An actuator actively arranged on the dome bearing has an electric motor and an actuating mechanism which has an actuating ring which is mounted rotatably on an inner sleeve, is held in an axially nondisplaceable manner and into the outer circumference of which an actuating slot is incorporated. Due to the actuating slot, the height can be adjusted only very slowly and disadvantageously also only in three stages. By contrast, in DE 10 2009 016 229 A1, the level control is intended to be able to be carried out more effectively, and therefore the actuator has a driving part which is in form-fitting operative engagement both with a first actuating part and with a second actuating part for a relative height adjustment between the driving part and the two actuating parts.

DE 10 2005 001 740 B3 discloses a suspension strut which has a spring mounted between spring plates. One of the two spring plates can be adjusted via an actuator. The actuator drives a threaded spindle which is operatively connected to the adjustable spring plate via a threaded nut. At least one axial stop is effective in an end position of the spring plate. The housing of the actuator has an impact disk against which the axial stop may come to bear.

DE 41 10 651 A1 discloses a spring system which has two main springs which are arranged so as to act in parallel on wheels on a common axle. One of the main springs connected in parallel may be switched on or off, and therefore the two springs could be loaded to a differing extent. A switchable or adjustable control element controls the respective main springs, wherein the springs which are connected in parallel and belong to a common axle could be connected in series by means of a gearing in order to improve the cornering stability.

DE 10 2004 018 701 B3 discloses a device for limiting the spring travel of a spring interacting with a damper. An additional spring limits the maximum spring travel and is connected to a structure mounted on the bodywork. The additional spring has two series-connected spring elements between which a disk cam is arranged. An actuating cylinder interacts with the disk cam in such a manner that the actuating cylinder, in a second switching position, acts on the disk cam and spans the first spring element and, in the first switching position, releases the disk cam such that both spring elements are effective.

DE 10 2005 031 012 A1 discloses a pressure stop for a vibration damper. An axially resilient elastomer body has a central rod. A securing stop determines the minimum operating length of the pressure stop by the securing stop coming to bear on a vibration damper surface facing the pressure stop.

EP 1 681 188 B1 describes a method for operating a spring carrier. The spring carrier has a second spring, the supporting force of which can be adjusted by means of the electric actuator in order to reach a defined distance of the supporting load from the support element. The supporting force generated by the prestressing force of the second spring raises the supporting load to a level in which the supporting force is greater than would be required to keep the supporting load at a normal level. Both springs are connected in series.

The wheel suspension of motor vehicles can therefore have a height adjustment means with which, for example, a constant distance of the underbody from the carriageway, which distance is based on an unloaded vehicle, can also be set for a loaded vehicle. However, the height may also be set individually depending on the particular requirement or the load. During city travel, for example, the distance can be set particularly high such that even curbs or bumps do not pose any risk. For a sporty, i.e. more rapid, manner of driving, the bodywork can be lowered in order to obtain aerodynamic effects. In this respect, level control devices of this type are entirely expedient. However, the latter are highly complicated to install and have an increased need for construction space, which is disadvantageous in particular with the very confined construction space conditions. Furthermore, the level control devices are highly cost-intensive and load the vehicle with additional weight, which has a negative effect on the fuel consumption.

Against this background, it is the object of the present invention to indicate a wheel suspension of the type mentioned at the beginning, in particular with respect to the spring system which has a particularly simple construction which requires only few components and is therefore of reduced complexity and of reduced wheel suspension weight and eliminates the further abovementioned disadvantages of level control devices and of the spring system.

This object is achieved by a wheel suspension having the features of claim 1. Further particularly advantageously refinements of the invention are disclosed by the dependent claims.

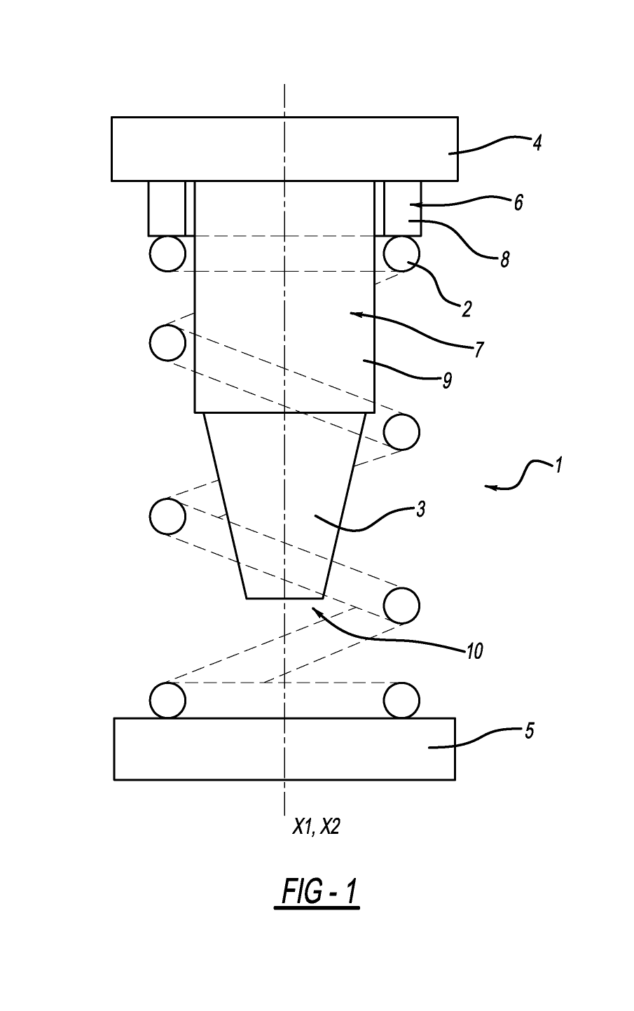

It should be pointed out that the features cited individually in the claims can be combined with one another in any technically expedient manner and indicate further refinements of the invention. The description additionally characterizes and specifies the invention, in particular in conjunction with FIG. 1.

It is intended that the first spring element has a first actuator, the second spring element at the same time also having a second actuator which is independent of the first actuator.

The first spring element can be designed, for example, as a main spring which is designed as a linear helical spring, the first spring element being mounted between two supporting elements which are preferably designed as spring plates. The spring plates are connected in a known manner to the corresponding components.

It is favorable within the context of the invention if the second spring element is designed as an additional spring which is arranged within the first spring element, i.e. preferably such that the two center lines of the two spring elements are congruent, i.e. coincide.

The first spring element can have a linear spring characteristic, the second spring element being able to hove a nonlinear spring characteristic. In this respect, provision can preferably be made to design the second spring element as a steel spring, a rubber spring, a pneumatic spring or the like.

It is expedient if the first actuator of the first spring element is arranged on an upper supporting element, i.e. on an upper spring plate. In this case, the first actuator can act directly on the foot of the spring element and can adjust said foot. It is favorable if the first actuator is designed with an annular operative region, as seen in longitudinal section, which is actuated by the actuator in accordance with a generated operative signal, i.e. from a neutral position along the center axis of the spring element is either oriented away from the upper supporting element or is moved in the direction toward the upper supporting element. The first spring element can thus be tensioned or relaxed individually depending on the operative signal. Of course, the operative region may be designed to be continuous or interrupted, as seen in the circumferential direction. If the operative region is not of interrupted design, as seen in the circumferential direction, virtually a sleeve-shaped operative region is produced. It is conceivable just to provide two operative projections, which are connected to the spring element, as the operative region. The operative projections may be arranged opposite each other with respect to the center axis.

In another favorable refinement, the second actuator of the second spring element is also arranged on the same supporting element as the first actuator, and therefore the center axes of both actuators are also congruent. The second actuator can also act directly on the second spring element analogously to the manner of operation of the first actuator. An annular operative region, as seen in longitudinal section, is also conceivable here, wherein the refinements described for the first actuator can also be provided for the second actuator. In a preferred refinement, the actuator has a housing in which the second spring element is accommodated. The second spring element is preferably designed as a rubber spring which can bear with the bearing side thereof against the lower supporting element opposite the upper supporting element, and is accommodated with the operative side thereof, which is opposite to the bearing side, in the housing. Known operative elements which are connected to the operative side are accommodated in the housing, and therefore the second spring element is likewise movable along the center axis. In a neutral position, the bearing side can bear against the lower supporting element or against the lower spring plate and either can be moved out of the housing or into the latter.

The suspension system advantageously has two spring elements or springs which are arranged in parallel and the center axes of which are preferably congruent, wherein the two spring elements connect an unsprung mass to a sprung mass. Both spring elements can preferably be adjusted (semi)actively at the feet thereof. The parallel connection results in a defined distribution of the static supporting loads between the two spring elements which can be displaced by the foot adjustments of the two spring elements. Conceivable examples of spring elements are steel springs, rubber springs or pneumatic springs. If, for example, a linear spring is combined with a nonlinear spring, a change in the spring characteristics of the entire module results from a displacement of the supporting portions between the two springs. The advantage of the use of one actuator per spring element also consists in the static supporting loads being able to be displaced between the two spring elements without affecting the vehicle level position.

For use in the vehicle, it is possible either for only two actuators to be arranged on each side of the front axle, or for only two actuators to be arranged on each side of the rear axle. Of course, it is also possible to arrange two actuators on each side both of the front axle and of the rear axle. In addition to a variation in the axle or vehicle level position, the driving dynamics or the driving comfort is influenced by varying the spring characteristic (linear/nonlinear) by displacement of the supporting portions (opposed actuator movement). With the actuator movement in the same direction, an active rolling compensation and an active starting torque or braking torque compensation can also be produced. The respective actuators can be activated electrically via control signals. Upon integration into an overall (semi)active suspension system, a control device and sensor arrangement are installed next to the actuator arrangement. Of course, it is conceivable to implement the function of the separate control device in a central control unit (CPU) of the vehicle. In this case, for example, the distances between the unsprung and the sprung mass in the vertical direction, the vehicle speed, the steering angle, the yaw rate, etc. can serve as input signals. The driver's requirement can also be input via an HMI (human machine interface). Upon integration with a continuously switchable damping system, signals from the damper control can likewise be input.

Further advantageous details and effects of the invention are explained in more detail below with reference to an exemplary embodiment in the single FIGURE, in which:

FIG. 1 shows a schematic illustration of a spring system in longitudinal section.

FIG. 1 shows a spring system 1 of a wheel suspension (not illustrated specifically) of a motor vehicle.

The spring system 1 has a first spring element 2 and at least one second spring element 3, the first spring element 2 being held between two supporting elements 4 and 5. The supporting elements 4 and 5 are designed as spring plates 4 and 5 which are fixed preferably nondisplaceably in a known manner on further components (not illustrated). In this respect, it is possible to refer to an upper supporting element 4 and a lower supporting element 5.

It is intended that the first spring element 2 has a first actuator 6, the second spring element 3 at the same time also having a second actuator 7 which is independent of the first actuator 6. The second spring element 3 is arranged within the first spring element 2. The second actuator 7 is surrounded by the first actuator 6. However, the respective center axes X1 and X2 of the spring elements 2 and 3 and also of the actuators 6 and 7 are congruent.

Both the first actuator 6 and the second actuator 7 are preferably arranged on the upper supporting element 4, i.e. on a common supporting element 4. However, it is also conceivable to arrange both actuators 6 and 7 on the lower supporting element 5. An arrangement of one of the actuators 6 or 7 on the upper supporting element 4 and of the other actuators 7 or 6 on the lower supporting element 5 is also possible.

The first spring element 2 is designed as a helical spring 2 having a linear spring characteristic. The second spring element 3 is designed by way of example as a rubber spring 3 having a nonlinear spring characteristic.

The first actuator 6 has an operative region 8 which is of virtually annular design, as seen in longitudinal section. The operative region 8 is connected directly to the first spring element 2. In principle, the first actuator 6 can be moved along the center axis X1 from a neutral position in such a manner that the first spring element 2 is tensioned further or relaxed. The first actuator 6 may be fastened to the upper supporting element 4 or integrated in the latter.

The second actuator 7 has a housing 9 in which the second spring element 3 can be inserted or moved out therefrom. The second spring element 3, which can also be referred to as the additional spring 3 has a bearing side 10 and an opposite operative side oriented toward the housing 9. In the example illustrated in FIG. 1, the bearing side 10 is spaced apart from the lower supporting element 5, the operative side is accommodated in the housing 9 and cannot be seen. In principle, provision may be made for the bearing side 10 to bear under a certain prestress against the lower supporting element 5 in a neutral position. The prestress of the second spring element 3 can be increased or reduced, or, as illustrated in FIG. 1, completely eliminated, by means of the second actuator 7.

Both actuators 6 and 7 can be activated by a signal-receiving and processing sensor arrangement and control device mechanism such that an individual setting of the spring system 1 in a manner most advantageous for the vehicle or corresponding to the driver's requirements is possible by specific activation of the first and/or the second actuator, wherein the two actuators 6 and 7 can each be adjusted in coordination with the other actuator 6 or 7 in each case. Similarly, the two actuators 6 and 7 are activatable independently of each other, which means, within the context of the invention, that the spring system 1 is adjusted not only via a single actuator. As a result of the fact that the two actuators 6 and 7 are actuable independently of each other, specific fine-tuning of the spring system 1 is possible.

### LIST OF DESIGNATIONS

1 Spring system
2 First spring element
3 Second spring element
4 Upper supporting element/spring plate
5 Lower supporting element/spring plate
6 First actuator
7 Second actuator
8 Operative region of 6
9 Housing of 7
10 Bearing side of 3
X1 Center line 1
X2 Center line 2

1. A wheel suspension which has a spring system (1) which has a first spring element (2) and at least one second spring element (3), wherein the first spring element (2) is held between two supporting elements (4, 5),
wherein
the first spring element (2) has a first actuator (6), the second spring element (3) at the same time also having a second actuator (7) which is independent of the first actuator (6).

2. The wheel suspension as claimed in claim 1,
wherein
the center axes (X1, X2) of the first and second spring elements (2, 3) and also of the first and second actuators (6, 7) are congruent.

3. The wheel suspension as claimed in claim 1,
wherein
the first spring element (2) has a linear spring characteristic, the second spring element (3) having a nonlinear spring characteristic.

4. The wheel suspension as claimed in claim 2,
wherein
the first spring element (2) has a linear spring characteristic, the second spring element (3) having a nonlinear spring characteristic.

5. The wheel suspension as claimed in claim 1,
wherein
the first actuator (6) and the second actuator (7) are arranged on a common supporting element (4, 5).

6. The wheel suspension as claimed in claim 2
wherein
the first actuator (6) and the second actuator (7) are arranged on a common supporting element (4, 5).

7. The wheel suspension as claimed in claim 3
wherein
the first actuator (6) and the second actuator (7) are arranged on a common supporting element (4, 5).

8. The wheel suspension as claimed in claim 4,
wherein
the first actuator (6) and the second actuator (7) are arranged on a common supporting element (4, 5).

9. The wheel suspension as claimed in claim 1,
wherein
the first actuator (6) has an annular operative region, as seen in longitudinal section.

10. The wheel suspension as claimed in claim 2
wherein
the first actuator (6) has an annular operative region, as seen in longitudinal section.

11. The wheel suspension as claimed in claim 3
wherein
the first actuator (6) has an annular operative region, as seen in longitudinal section.

12. The wheel suspension as claimed in claim 4,
wherein
the first actuator (6) has an annular operative region, as seen in longitudinal section.

13. The wheel suspension as claimed in claim 1,
wherein
the second actuator (7) has a housing (9) in which the second spring element (3) is accommodated.

14. The wheel suspension as claimed in claim 2,
wherein
the second actuator (7) has a housing (9) in which the second spring element (3) is accommodated.

15. The wheel suspension as claimed in claim 3,
wherein
the second actuator (7) has a housing (9) in which the second spring element (3) is accommodated.

16. The wheel suspension as claimed in claim 4,
wherein
the second actuator (7) has a housing (9) in which the second spring element (3) is accommodated.

17. The wheel suspension as claimed in claim 1,
wherein
the first spring element (2) is designed as a steel spring, the second spring element (3) being designed as a rubber spring.

18. The wheel suspension as claimed in claim 2
wherein
the first spring element (2) is designed as a steel spring, the second spring element (3) being designed as a rubber spring.

19. The wheel suspension as claimed in claim 3
wherein
the first spring element (2) is designed as a steel spring, the second spring element (3) being designed as a rubber spring.

20. The wheel suspension as claimed in claim 4,
wherein
the first spring element (2) is designed as a steel spring, the second spring element (3) being designed as a rubber spring.
